(19) United States
(12) Patent Application Publication
(10) Pub. No.: US 2018/0307909 A1
(43) Pub. Date: Oct. 25, 2018

(54) VIRTUAL REALITY NETWORK MANAGEMENT USER INTERFACE

(71) Applicant: Walmart Apollo, LLC, Bentonville, AR (US)

(72) Inventors: John J. O'Brien, Farmington, AR (US); David C. Cox, Rogers, AR (US); Tim W. Webb, Rogers, AR (US); Jason R. Todd, Lowell, AR (US); Michael David Smith, Rogers, AR (US)

(21) Appl. No.: 15/958,998

(22) Filed: Apr. 20, 2018

Related U.S. Application Data
(60) Provisional application No. 62/488,339, filed on Apr. 21, 2017.
(60) Provisional application No. 62/488,331, filed on Apr. 21, 2017.

(51) Int. Cl. G06K 9/00; H04L 12/24; G06T 19/00; G06F 3/01; G06F 3/042; G06F 3/0346; G06T 11/00; G06F 17/30

(52) U.S. Cl. CPC G06K 9/00671; H04L 41/22; G06T 19/006; G06F 3/017; G06F 17/30061; G06F 3/0346; G06F 3/014; G06F 3/013; G06T 11/00; G06F 3/0426

(57) ABSTRACT

Systems, apparatuses, and methods are provided herein for providing a virtual reality (VR) appliance interface. A system for providing a VR user interface for managing network data flow comprises a network communication device configured to communicate with a plurality of nodes on a network, a motion sensor configured to receive user input, a VR display device, and a control circuit being configured to aggregate data flow information from the plurality of nodes via the network communication device, generate graphical representations of a plurality of data packets traveling between one or more of the plurality of nodes based on the data flow information, determine display locations for the graphical representations of the plurality of data packets, cause the VR display device to display the graphical representations of the plurality of data packets in the data flow between the plurality of nodes in the three-dimensional space of a VR environment.

### CROSS-REFERENCE TO RELATED APPLICATION

This application claims the benefit of U.S. Provisional Application No. 62/488,339 filed Apr. 21, 2017 and U.S. Provisional Application No. 62/488,331 filed Apr. 21, 2017, both of which are incorporated herein by reference in their entirety.

### TECHNICAL FIELD

This invention relates generally to computer user interfaces.

### BACKGROUND

Network analysts and administrators are people who are responsible for keeping an organization's computer network up to date and running smoothly. Their responsibilities include ensuring network speed, detecting and addressing potential issues on the network, and protecting the network from threats.

### BRIEF DESCRIPTION OF THE DRAWINGS

Disclosed herein are embodiments of apparatuses and methods for providing a virtual reality network management interface. This description includes drawings, wherein:

FIG. 1 comprises a block diagram of a system as configured in accordance with various embodiments of these teachings;

FIG. 2 comprises a flow diagram of a method in accordance with various embodiments of these teachings;

FIG. 3 comprises a flow diagram of a method in accordance with various embodiments of these teachings;

FIG. 4 comprises an illustration of a device as configured in accordance with various embodiments of these teachings;

FIG. 5 comprises an illustration of a device as configured in accordance with various embodiments of these teachings;

FIG. 6 comprises a flow diagram of a method in accordance with various embodiments of these teachings;

FIG. 7 comprises a flow diagram of a method in accordance with various embodiments of these teachings;

FIG. 8 comprises an illustration a user interface in accordance with various embodiments of these teachings; and

FIG. 9 comprises an illustration a user interface in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein for providing a virtual reality network and appliance management user interfaces. In one embodiment, a system for providing a virtual reality (VR) user interface for managing networked appliances comprises an appliance communication device configured to communicate with a plurality of appliances on a network, a motion sensor configured to receive user input, a VR display device, and a control circuit coupled to the appliance communication device, the motion sensor, and the VR display device. The control circuit being configured to: aggregate configuration data and real-time status information from the plurality of appliances via the appliance communication device, generate graphical representations of the plurality of appliances based on the configuration data and the real-time status information associated with each of the plurality of appliances, the graphical representations of each the plurality appliances comprising at least one visual indicator associated with a characteristic of a corresponding appliance, determine display locations for the graphical representations of the plurality of appliances in a three-dimensional space, cause the VR display device to display the graphical representations of the plurality of appliances in the three-dimensional space of a VR environment, detect user motion via the motion sensor, determine an action in the VR environment based on the user motion, in an event that the action corresponds to an inspection action: selectively display the configuration data and/or the real-time status information of one or more of the plurality of appliances selected by a user, in an event that the action corresponds to an appliance modification action: determine a configuration change command for at least one appliance selected by the user based on the action, forward the configuration change command to the at least one appliance, and update the display of the plurality of appliances based on an updated configuration data and an updated real-time status information aggregated from the plurality of appliances after the configuration change command is executed.

In one embodiment, a system for providing a virtual reality (VR) user interface for managing network data flow comprises a network communication device configured to communicate with a plurality of nodes on a network, a motion sensor configured to receive user input, a VR display device, and a control circuit coupled to the network communication device, the motion sensor, and the VR display device. The control circuit being configured to: aggregate data flow information from the plurality of nodes via the network communication device, generate graphical representations of a plurality of data packets traveling between one or more of the plurality of nodes based on the data flow information, a graphical representation of a data packet of the plurality of data packets comprising at least one visual indicator associated with a characteristic of the data packet, determine display locations for the graphical representations of the plurality of data packets in a three-dimensional space, cause the VR display device to display the graphical representations of the plurality of data packets in the data flow between the plurality of nodes in the three-dimensional space of a VR environment, detect user motion via the motion sensor, determine an action in the VR environment based on the user motion, in an event that the action corresponds to an inspection action: selectively display details of one or more of the plurality of data packets selected by a user, in an event that the action corresponds to a modification action: determine a rerouting command for at least one data packet selected by the user based on the action, forward the rerouting command to at least one node, and update the display of the plurality of data packets based on an updated data flow information aggregated from the network after the rerouting command is executed.

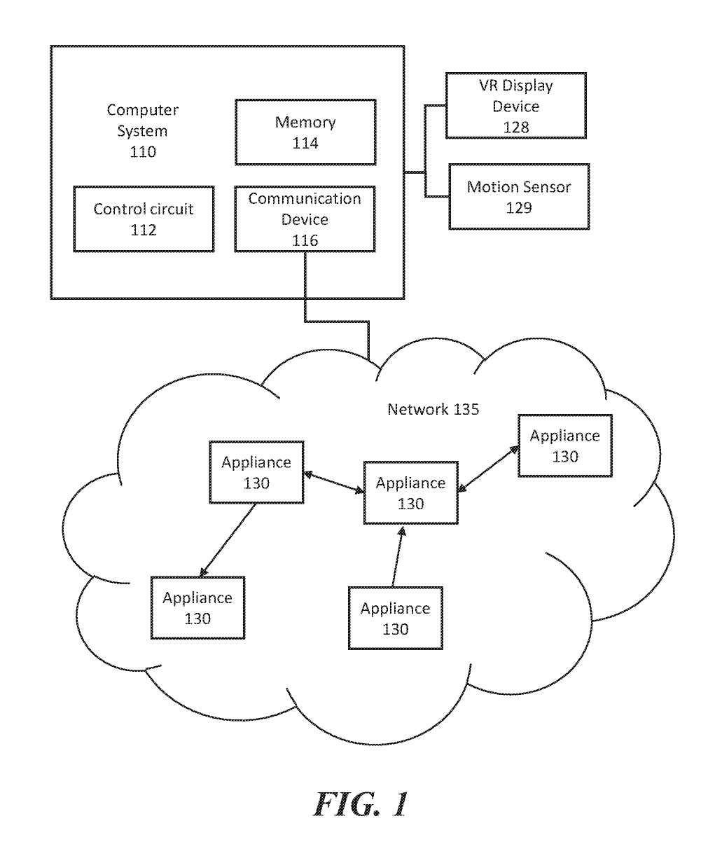

Referring now to FIG. 1, a system for providing a virtual reality network interface is shown. The system comprises a VR display device 128, a motion sensor 129, and a computer system 110 communicating with a network of appliances 130.

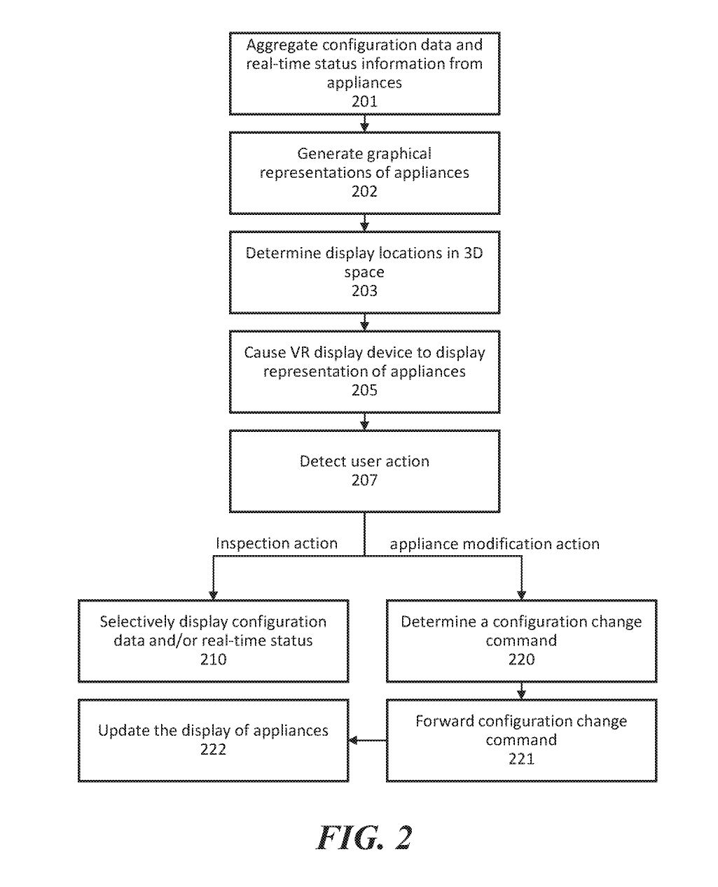

The computer system 110 comprises a control circuit 112, a memory 114, and a communication device 116. The computer system 110 may comprise one or more of a server, a central computing system, a desktop computer system, a personal device, a portable device, and the like. The control circuit 112 may comprise a processor, a microprocessor, a central processing unit (CPU), a graphics processing unit (GPU) and the like and may be configured to execute computer readable instructions stored on a computer readable storage memory 114. The computer readable storage memory 114 may comprise volatile and/or non-volatile memory and have stored upon it, a set of computer readable instructions which, when executed by the control circuit 112, causes the central computer system 110 to provide a VR user interface for managing networked appliances and/or traffic via the VR display device 128 based communications with the network 135. The communication device 116 may comprise one or more of a network adapter, a data port, a network port and the like. In some embodiments, the communication device 116 may comprise a plurality of network monitoring devices distributed at or between nodes and/or appliances throughout the network 135. Generally, the communication device 116 may be configured to allow the control circuit 112 to aggregate information from appliances 130 and/or network nodes on the network 135. In some embodiments, the memory 114 may further configured to store past network configuration and/or traffic information aggregated from the network 135. In some embodiments, the memory 114 may store user profiles comprising user configurations of the VR user interface. In some embodiments, the computer executable instructions may cause the control circuit 112 of the computer system 110 to perform one or more steps of the methods described with reference to FIGS. 2, 3, 6, and 7 herein.

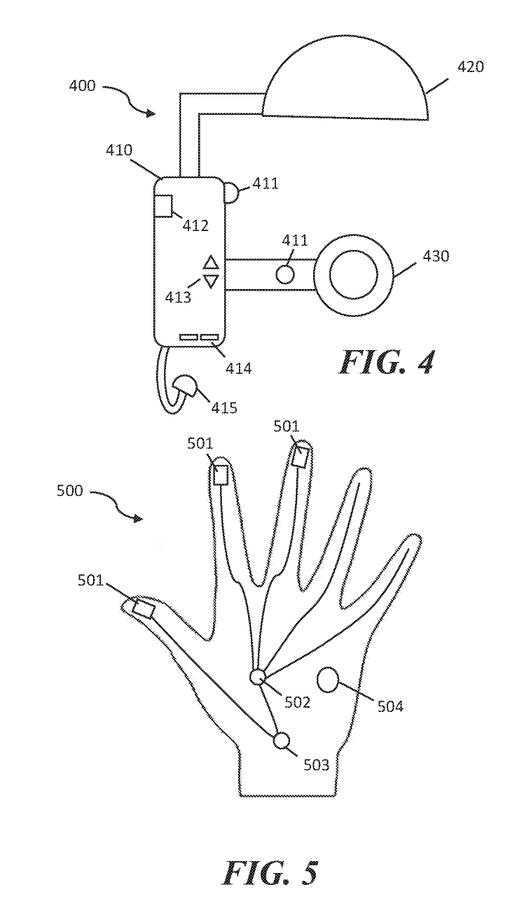

The VR display device 128 comprises a display device configured to provide a virtual reality environment to a user based on communications with the computer system 110. In some embodiments, the VR display device 128 may comprise a thin client device controlled by the control circuit 112 and/or comprise a processor-based device separate from the computer system 110. The VR display device 128 may comprise a stereoscopic display and one or more user input/output devices. In some embodiments, the VR display device may comprise a head-mounted display device comprising one or more of a display screen, an audio device, an eye movement sensor, a wireless communication device, and a vibration feedback device. In some embodiments, the VR display device 128 may comprise one or more of an optical sensor, a camera, a head motion tracker, an eye tracker, touch inputs, a controller, a microphone, a vibration feedback sensor, a headset, a speaker, and the like. In some embodiments, the VR display device 128 may comprise a head mounted display, a VR room, a VR dome display, a projection display, a hologram display, and the like. In some embodiments, the VR display device 128 may comprise a single viewer display or a multi-user display. An example of a VR display device is described with reference to FIG. 4 herein.

The motion sensor 129 may comprise one or more of an optical sensor, a camera system, a head motion tracker, an eye tracker, a gesture sensor, a gesture tracking glove, a wearable sensor, and the like. The motion sensor 129 may generally be configured to detect the direction and/or speed of one or more body parts of a user. In some embodiments, the motion sensor 129 may be attached/worn by the user and/or may monitor the user's movement from a distance. In some embodiments, the motion sensor 129 may comprise a plurality of sensor types (e.g. an eye tracker and a gesture tracking glove) and may be implemented as one or more physically separated device. In some embodiments, the motion sensor 129 may be integrated with and/or comprise part of the VR display device 128. The VR display device 128, the motion sensor 129, and the computer system 110 may communicate with each other via one or more wired and/or wireless communication channels. While one set of VR display device 128 and motion sensor 129 are shown, in some embodiments, a computer system 110 may be configured to provide VR environments to a plurality of sets of VR display devices 128 and motion sensors 129 associated with a plurality of users. In some embodiments, the computer system 110 may further allow a plurality of users to interface with each other and share a view of the VR environment through a plurality of sets of VR display device 128 and motion sensors 129.

The network 135 may comprise a plurality of nodes and/or appliances 130 communicating through a plurality of data connections. In some embodiments, the network 135 may comprise one or more of a private network, a virtual private network (VPN), an Ethernet, a local area network (LAN), an enterprise network, a home network, a secured network, a portion of the Internet, and the like. In some embodiments, the network 135 may be coupled to one or more external networks (e.g. Internet, other private networks) via one or more appliances 130. In some embodiments, the network 135 may further comprise other servers and/or end user devices (e.g. laptop computer, mobile device, terminal system, etc.). In some embodiments, the network 135 may comprise a secured network behind a common firewall. In some embodiments, the network 135 may comprise any number of nodes, appliances, and/or terminal devices located in one or more geographic locations. In some embodiments, data traveling on data connections between the nodes, appliances, and/or terminals devices may use a standardized transport protocol such as the Transmission Control Protocol/Internet protocol (TCP/IP). In some embodiments, the network 135 may use a proprietary communication protocol to communicate within the network.

The appliances 130 on the network may comprise computer appliances with software or firmware that is specifically designed to provide a specific computing resource. In some embodiments, the hardware and software in an appliance 130 may be delivered as an integrated product and may be pre-configured before delivery to a customer to provide a turnkey solution for a particular application. Unlike general purpose computers, appliances are generally not designed to allow the customers to change the software and the underlying operating system, or to flexibly reconfigure the hardware. In some embodiments, an appliance may comprise a physical appliance device or a virtual appliance, which has similar functionality to a dedicated hardware appliance but is distributed as a software virtual machine image for a hypervisor-equipped device. In some embodiments, an appliance 130 may comprise no or minimum user input/output devices (e.g. power switch, reset button, status indicator LEDs, etc.). In some embodiments, at least some configurations of an appliance 130 may only be accessed through another user interface device on the network 135.

In some embodiments, the appliances 130 on the network 135 may comprise one or more a firewall appliance, a security appliance, a network switch, a router, a storage appliance, a software appliance, a JeOS (Just Enough Operating Systems) device , a virtual machine appliance, a digital video recorder, a residential gateway, a network storage device, a video game console, a printer device, a scanner device, a display device, an Internet of Things (IoT) device, an industrial automation appliance, etc. The connections between the appliances 130 in FIG. 1 are for illustration only, appliances may be connected in various ways on a network. In some embodiments, one or more appliances 130 may further be coupled to one or more of an external network, other nodes of the network, and/or user devices on a network. For example, a firewall appliance may be connected between an external network and the other appliances on the network 135, and a router may be coupled between the firewall appliance and user devices. While the computer system 110 is shown outside of the network 135, in some embodiments, the computer system 110 may be part of the network 135. In some embodiments, the computer system 110 may comprise or access a central server and/or central appliance through which some or all network communication passes through. While only appliances are shown in the network 135, the network 135 may comprise other types of processor-based devices such as personal computers, server systems, and mobile devices.

Referring now to FIG. 2, a method for providing a virtual reality appliance interface is shown. In some embodiments, the steps shown in FIG. 2 may be performed by a processor-based device such as a control circuit executing a set of computer readable instructions stored on a computer readable memory. In some embodiments, one or more steps of FIG. 2 may be performed by one or more of the control circuit 112 of the computer system 110 and/or the VR display device 128 described with reference to FIG. 1 herein.

In step 201, the system aggregates configuration data and real-time status information from the plurality of appliances via an appliance communication device. In some embodiments, the configuration data may generally refer to appliance configurations that may be static, dynamic, or changeable by a user. For example, configurations for a firewall appliance may comprise one or more of a trusted IP list, a banned IP list, spam filter settings, etc. In another example, configurations for a Wi-Fi router appliance may comprise network password, wireless channel, DNS Server, etc. In some embodiments, real-time status may comprise status information that is updated continuously based on the functions performed by the appliance. For example, for a Wi-Fi router appliance, real-time status information may comprise connectivity to the Internet, identities of connected devices, upload speed, download speed, bandwidth usage, etc. In another example, for a firewall appliance, real-time status information may comprise files passing through or blocked by the firewall.

In some embodiments, an appliance communication device may comprise one or more of a network adapter, a data port, a network port and the like. In some embodiments, the appliance communication device may comprise a plurality of network monitoring devices distributed at or between nodes and/or appliances throughout the network. In some embodiments, the appliance communication device may comprise the communication device 116 described with reference to FIG. 1 herein. In some embodiments, the system may aggregate configuration data and real-time status information by communicating with the appliance. For example, the system may periodically request configuration and status information from the monitored appliances. In some embodiments, the system may aggregate configuration data and real-time status information by monitoring and inspecting the communications on the network. For example, the system may check for data packets arriving at one or more nodes of the network to determine whether one or more appliances is failing to forward packets and/or respond to requests for data. In some embodiments, the system may send out a data packet configured to be processed and/or forwarded by a plurality of appliance and determine the statuses and/or configurations of the appliances based the routing and handling of the data packet.

In step 202, the system generates graphical representations of the plurality of appliances. In some embodiments, a graphical representation of an appliance may comprise an icon, a 3D object, a geometrical shape, a model of the appliance, and the like. In some embodiments, the graphical representation of an appliance may be generated based on the configuration data and the real-time status information associated with the appliance. In some embodiments, the graphical representations of each the plurality appliances may comprise at least one visual indicator associated with a characteristic of the corresponding appliance. In some embodiments, a visual indicator may comprise one or more of shape, size, color, texture, brightness, location, orientation, image, icon, text, symbol, animation, etc. In some embodiments, a visual indicator may generally be any visual element that distinguishes a graphical representation from another. In some embodiments, characteristic of an appliance may comprise one or more of status information, capability, category, type, functionality, configuration, connection type, etc. In some embodiments, the appearance of the graphical representation of an appliance may correspond to the type or category of the appliance. For example, a first shape (e.g. a switch) may be used to represent router type network appliance and a second shape (e.g. a file cabinet) may be used represent network storage type appliances. In another example, a graphical representation of an appliance may comprise a status indicator representing one or more real-time statuses of the appliance. For example, an appliance experiencing bandwidth congestion may be color-coded red, an off-line appliance may be color-coded gray, etc. In yet another example, the graphical representation of the appliance may comprise one or more icons that represent one or more functions provided by the appliance and/or one or more configuration settings of the appliance. For example, a firewall appliance providing spam filtering may include a spam filter icon. In some embodiments, the characteristics of an appliance that are shown through the graphical representation of the appliance may be configurable by the user. For example, the user may select one or more types of visual indicators to represent one or more configuration, real-time status, and/or other appliance information in the VR user interface. In some embodiments, the system may store the configured graphical representations associated with a plurality of the appliances and use the stored display configuration for subsequent sessions. In some embodiments, the representation of appliance may further comprise sound, vibration, and/or scent signatures. For example, a user may wear a plurality of vibration devices while interacting with the VR user interface. Different appliances experiencing issues may trigger vibration devices at different locations to alert the user.

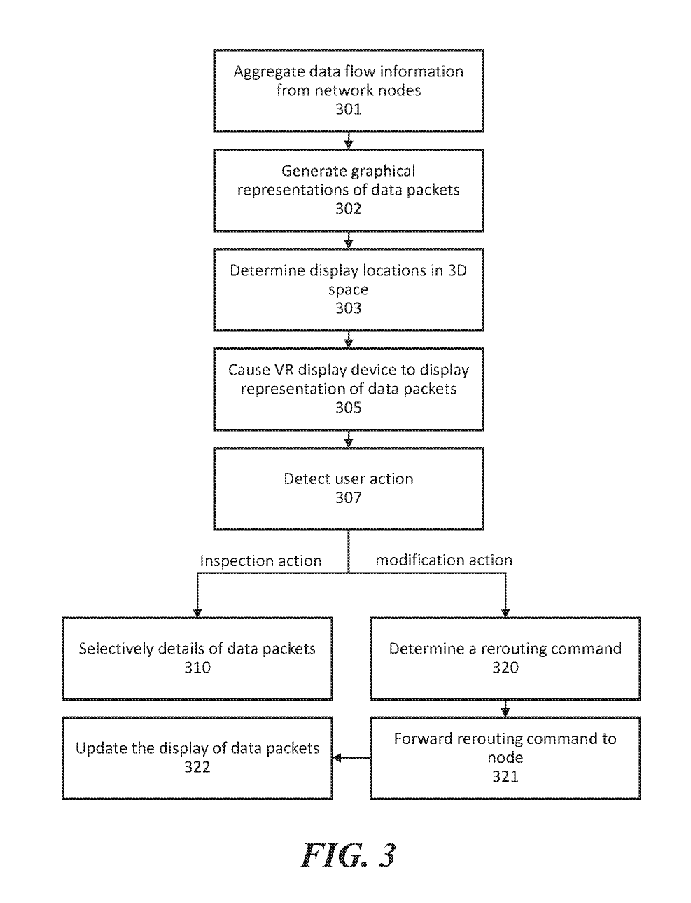

In some embodiments, the system further generates graphical representations of data flow between the appliances to display in the VR environment. In some embodiments, the graphical representations of data flow may comprise representations of data channels, data packets, direction of data flow, volume of data flow, etc. In some embodiments, data channels may correspond to direct wired or wireless connections between nodes and appliances on a network. In some embodiments, the data packets may be represented as 2D objects, 3D objects, geometrical shapes, and the like. In some embodiments, the graphical representations of data flow may be generated based on real-time status information aggregated from a plurality of network nodes. In some embodiments, nodes of a network may comprise appliances, network switches, network routers, general purpose computers, user terminals, end user devices, and the like. In some embodiments, graphical representations of data channel and/or data packets may comprise at least one visual indicator associated with a characteristic of the data flow. In some embodiments, a visual indicator may comprise one or more of shape, size, color, texture, brightness, location, orientation, image, icon, text, symbol, animation, etc. In some embodiments, a visual indicator may generally be any visual element that distinguishes a graphical representation from another. In some embodiments, the visual indicator may represent one or more of data packet origin, data packet destination, file type, data security level, data flow speed, etc. In some embodiments, the representation of data flow on the network and the display locations of data packets may be generated based on one or more steps described with reference to FIG. 3 herein.

In step 203, the system determines display locations for the graphical representations of the plurality of appliances in a three-dimensional space. In some embodiments, the display locations of the appliances may be configurable by users. For example, the users may arrange and sort appliances on the network based on various characteristics of the appliances. In some embodiments, a user may select and place one or more appliances into “frames” for inspection and monitoring. The selected appliances may remain visible and accessible through the frame as the user navigates and manipulates the other representations of appliances. The user may further select a display location of the frame in the VR environment. In some embodiments, display locations of appliances configured by the user may be saved by the system and used to display the appliances in subsequent VR sessions. In some embodiments, the locations of each graphical representation of appliances may comprise x, y and z coordinates relative to a reference point in the 3D space. In some embodiments, the graphical representations of appliances and/or frame containing appliances may be arranged such that the appliances are displayed on a plurality of planes.

In some embodiments, the system may determine display locations for each of the appliances on the network in the VR 3D space. In some embodiments, the display locations may be determined based on the connections between network nodes in the network. In some embodiments, the layout of the appliances may represent a network hierarchy of the appliances. In some embodiments, the appliances may be laid out such that the appliances with direct communications are situated next to each other. For example, if an incoming data packet first passes through a modem appliance, then a firewall appliance, and then a router appliance, the graphical representations of the modem appliance, the firewall appliance, and the router appliance may be arranged left to right or front to back in that order. Devices that connect to the external network through the router appliance may then be positioned near the modem appliance on the opposite side of the firewall appliance. In some embodiments, the locations of the graphical representations of the plurality of appliances may correspond to the functions of the appliances. For example, networking appliances may be represented in one cluster while consumer appliances may be represented in a separate cluster. In some embodiments, locations of the appliance may correspond to associated user groups. For example, appliances associated with different departments of a company may be represented in separate clusters. In some embodiments, display locations of appliances may correspond to physical locations of the appliances. For example, on a VPN, appliances located in different geographic areas may be presented in different clusters. In some embodiments, the system may allow the user to switch between different arrangements and views of the appliances.

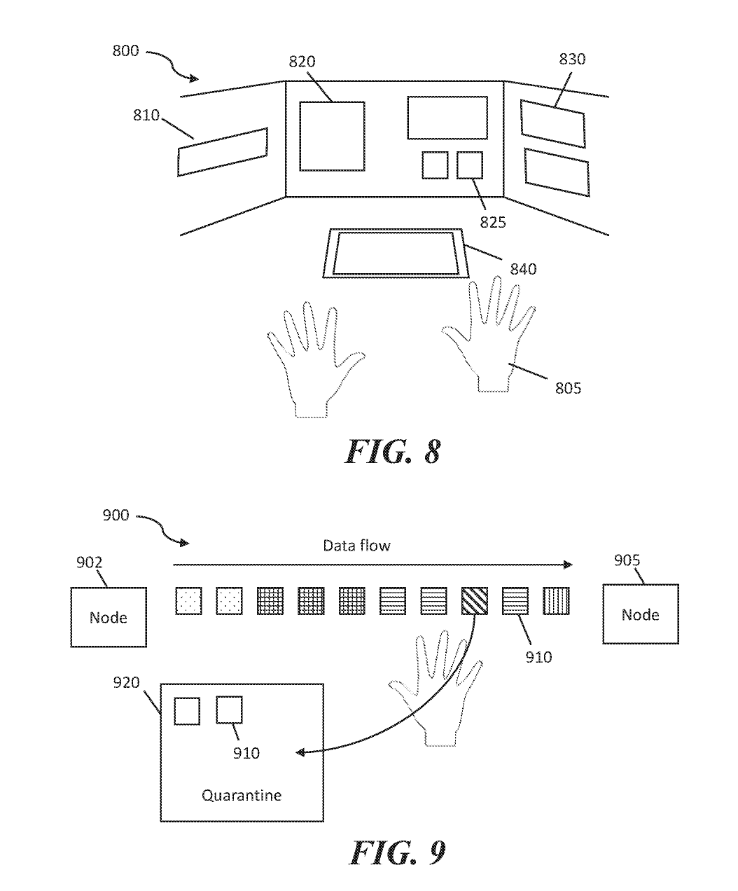

In step 205, the system causes a VR display device to display the graphical representations of the plurality of appliances in the three-dimensional space of a VR environment. In some embodiments, graphical representations generated in step 202 are displayed according to the display locations determined in step 203 in the 3D space of the VR environment. In some embodiments, the VR environment comprises a main display area where a user can navigate through the monitored appliances on the network. In some embodiments, the user may move, rotate, zoom in, and zoom out through the graphical representations of the appliances in the VR environment with hand motion, body motion, and/or eye movement. In some embodiments, the VR environment may further include other virtual tools for network management. In some embodiments, the VR environment may comprise representations of one or more of an interactive keyboard, interactive buttons, an interactive menu configured to receive user inputted selections and/or commands. In some embodiments, the VR environment may emulate a virtual workspace comprising virtual inputs/output devices, virtual control elements, and/or decorative elements (e.g. plants, desk, walls, etc.). In some embodiments, the VR environment may comprise representations of the user's hand and/or arm to help users locate their hands in the VR space. In some embodiments, the VR environment may comprise representations of one or more “picture frames” configured to display data associated with one or more appliances selected by the user and placed into a picture frame. In some embodiments, an appliance selected and placed into a frame may remain visible and accessible to the user as the user navigates through other appliances in the main display area. In some embodiments, configured pictures frames may be saved in the user's profile and be displayed according to the user configuration in subsequent sessions. Examples of VR user interfaces are described with reference to FIGS. 8 and 9 herein.

In some embodiments, the VR appliance management user interface further allows a plurality of users to share a virtual workspace. In some embodiments, users may share a view the representations of the appliances on the network. In some embodiments, manipulations to the display of representations of the appliances and the network made by one user may be shown to other users viewing the same workspace. For example, frames configured by one user may be displayed to another user at the same location in the VR environment. In some embodiments, users may share individual frames with selected users. For example, a user may configure two separate frames for monitoring two sets of appliances and share only one of the frames with a second user. In some embodiments, the system may further relay communications (e.g. text, voice, gesture) between the users. In some embodiments, the VR environment may comprise displays of avatars of each participant of the VR user interface. In some embodiments, users of a VR interface may be given different levels of control permission. For example, an experienced network administrator may be permitted to cause real-time changes to the network while a network administrator-in-training may only be permitted to observe the network. In some embodiments, the VR environment may further be configured to display historical network data for training purposes. In some embodiments, a network administrator-in-training may train using historical or simulated network data. In some embodiments, the system may display actions taken by an experienced network administrator to a trainee as a teaching tool. In some embodiments, the VR environment may further be configured to simulate network activity based on changes to appliance configuration. In some embodiments, the VR environment may be configured to display the statuses of nodes and/or data flow at an earlier time based on cached information and/or be configured to simulate the status of nodes and/or data flow at a later time based on predictive simulation. In some embodiments, the VR environment may allow the user to pause the display of the network such that the user can view and interact with the state of a network at a fixed point in time.

In step 207, the system detects a user action. In some embodiments, the user action may be detected via a motion sensor. In some embodiments, the motion sensor may comprise one or more of an optical sensor, a camera, a head motion tracker, an eye tracker, a gesture sensor, a gesture tracking glove, a wearable sensor, and the like. In some embodiments, the motion sensor may comprise a plurality of sensor types (e.g. eye tracker and gesture tracking glove) and may be implemented with one or more physical devices. In some embodiments, the motion sensor may comprise the motion sensor 129 described with reference to FIG. 1 herein. In some embodiments, user motions may comprise one or more of point, pinch, flick, two-finger point, drag, press, long stare, voice command (e.g. “open,” “change”), etc. Generally, the system may be configured to detect a variety of motions associated a variety of commands. In some embodiments, the user may select an appliance and/or a frame by pointing to or touching the representation of the appliance/frame in the VR space. In some embodiments, the system may be configured to display a command menu in response to a selection action. For example, if a user touches a representation of an appliance in the VR space, the system may display a menu of actions next to the representation of the appliance. The user may then select an action from the list by touching the menu and/or through voice command. In some embodiments, the user may directly perform a motion over the representation to perform an action. For example, performing a reverse-pinch on a representation of an appliance may correspond to an inspection action.

In the event that the action detected in step 207 corresponds to an inspection action, in step 210, the system selectively displays the configuration data and/or the real-time status information of one or more of the plurality of appliances selected by a user. In some embodiments, the inspection action may correspond to the user performing a reverse pinch gesture on the visual representation of the appliance. In some embodiments, the inspection action may correspond to the user pointing and/or touching the visual representation of the appliance and saying “inspect,” “details,” “status,” and the like. In some embodiments, the inspection action may comprise the user placing an inspection tool over the representation of the appliance or moving the representation of the appliance into an area of the VR space corresponding to an inspection area. In response to such action, the system may display detailed configuration data, status information, and/or appliance characteristic to the user. For example, the system may display data packets currently passing through the appliance, the current throughput rate of the appliance, the current CPU usage of the appliance, etc. Generally, the system may be configured to any type of appliance information through the VR interface. In some embodiments, the display information may further be navigable, sortable, searchable, and/or movable through user motions in the 3D space. In some embodiments, the system may be configured to convert the configuration data and/or the real-time status information of appliances to natural language descriptions before displaying the configuration data and/or the real-time status information in the VR environment. For example, instead of “error 2314,” the environment may display that “the appliance has a MAC address conflict.” In some embodiments, the translation of appliance status to natural language may be performed based on a lookup table and/or by parsing search results from a search engine.

In the event that the action detected in step 207 corresponds to a configuration change command, the process may proceed to step 220. In step 220, the system determines a configuration change command for the appliance selected by the user. In some embodiments, a configuration change command may comprise an action associated with a modification of the appliance's settings. In some embodiments, the user may perform a specified gesture (e.g. swipe, pinch) or a combination of a gesture and voice command (e.g. touch and say “reset”) on a representation of an appliance to turn the appliance on or off, adjust specific functions the appliance, initiate a reset, and/or switch the appliance between operating modes. In some embodiments, when an appliance is selected, a set of configuration change commands may be displayed to the user for selection. In some embodiments, the configuration change commands may be inputted through voice command and/or a virtual input device (e.g. virtual keyboard, virtual keypad, etc.). In some embodiments, a user may select a specific configuration from the appliance details displayed in step 210 to modify. In some embodiments, the user may select a plurality of appliances to perform a batch configuration change. In some embodiments, the user may select a set of configurations from a first appliance and drop the configuration on a second appliance to copy and paste the configuration between devices. In some embodiments, prior to step 221, the system may be configured to simulate the network according to the selected configuration change.

In step 221, the configuration change command determined in step 220 is forwarded to the selected appliance. In some embodiments, the system may be configured to use an appliance-specific lookup table to determine the configuration change command for the appliance prior to sending the change command. After the command is forwarded, in step 222, the system updates the display of the plurality of appliances based on the updated configuration data and the updated real-time status information aggregated from the plurality of appliances after the configuration change command is executed.

In some embodiments, after steps 220 and 222, the process may return to step 201 and the system may continuously update the VR environment in response to both updated information from the appliances and user actions.

In some embodiments, a similar process may be provided with historical or simulated data from a network. For example, steps 202-205 may be performed with data previously aggregated from a network or simulated by a computer system. Instead of step 221 and 222, the system may simulate changes to the network based on the selected configuration change command and display the simulated network to the user. In some embodiments, historical or simulated data may be used for new analyst training and/or analysis of a past network issue (e.g. connection failure, security breach, etc.).

Referring now to FIG. 3, a method for providing a virtual reality network management user interface is shown. In some embodiments, the steps shown in FIG. 3 may be performed by a processor-based device such as a control circuit executing a set of computer readable instructions stored on a computer readable memory. In some embodiments, one or more steps of FIG. 3 may be performed by one or more of the control circuit 112 of the computer system 110 and/or the VR display device 128 described with reference to FIG. 1 herein.

In step 301, the system aggregates data flow information from a plurality of nodes of a network via a network communication device. In some embodiments, data flow information may comprise information relating to data packets traveling to and from one or more nodes in a network. In some embodiments, a node in a network may comprise one or more of an appliance, a computer device, a user device, and other soft and/or hardware components of a network. In some embodiments, data flow information may comprise details of data packets, contents of data packets, locations of data packets, transfer speed of data packets, and/or paths of data packets.

In some embodiments, a network communication device may comprise one or more of a network adapter, a data port, a network port and the like. In some embodiments, the network communication device may comprise a plurality of network monitoring devices distributed at or between nodes throughout the network. In some embodiments, the network communication device may comprise the communication device 116 described with reference to FIG. 1 herein. In some embodiments, the system may aggregate data flow information by communicating with devices on the network and/or monitoring and inspecting the communications on the network. For example, the system may inspect data packets received at one or more nodes of the network to collect information on the data flow of the network.

In step 302, the system generates graphical representations of a plurality of data packets traveling between one or more of the plurality of nodes on the network. In some embodiments, the graphical representations may be generated based on the data flow information aggregated in step 301. In some embodiments, graphical representations of data flow may be generated based on real-time status information aggregated from a plurality of network nodes. In some embodiments, a graphical representation of a data packet may comprise an icon, a 3D object, a geometrical shape, a model of the appliance, and the like. In some embodiments, a graphical representation of a data packet may be generated based on the data information extracted from the data packet and/or other transport data recorded by the system and/or one or more nodes. In some embodiments, a graphical representation of a data packet may comprise at least one visual indicator associated with a characteristic of the data packet. In some embodiments, a visual indicator may comprise one or more of shape, size, color, texture, brightness, location, orientation, image, icon, text, symbol, animation, etc. In some embodiments, a visual indicator may generally be any visual element that distinguishes a graphical representation from another. In some embodiments, characteristic of a data packet may comprise one or more of data packet origin, data packet destination, file type, data security level, data trust level, data flow speed, etc. In some embodiments, the flow speed of a data packet may be determined based on the time that the data packet first enters the network from an internal or external source. In some embodiments, the characteristics of a data packet may comprise any information extracted from a header, a trailer, and the payload of the data packet. In some embodiments, a graphical representation of a data packet may comprise a color visual indicator corresponding to the file type of the payload (e.g. blue for streaming video, red for email, etc.), origin of the data packet (e.g. blue for internal source, green for trusted external source, and red for unverified external source, etc.), or payload security (e.g. orange for encrypted data, white for unencrypted data, etc.). In some embodiments, the characteristics of a data packet that are shown through the graphical representation of the data packet may be selectable by the user. For example, the user may select one or more types of visual indicators to represent one or more data or transport information of the data packet in the VR user interface. In some embodiments, the system may store the configured graphical representations associated with a plurality of the data packet types and used the stored display configuration for subsequent sessions. In some embodiments, representations of data packets may further comprise sound, vibration, and/or scent signatures. For example, a first sound signature may be associated with data packets originated from an external data source and a second sound signature may be associated with data packets originated from an internal data source, and analysts may determine the usage of the communication channel based on listening.

In some embodiments, the system further generates graphical representations of nodes on the network to display in the VR environment. In some embodiments, the appearance of the graphical representation of the node may correspond to the type and/or the category of the node. For example, a first shape (e.g. a switch) may be used to represent router type network appliance and a second shape (e.g. a laptop) may be used represent a user computer. In another example, the graphical representations of the nodes may comprise a status indicator representing one or more real-time status of the nodes. For example, a node experiencing bandwidth congestion may be color-coded red, an offline node may be color-coded gray, etc. In another example, the graphical representation of a node may comprise one or more icons that represent one or more functions provided by the node and/or one or more configuration settings of the node. In some embodiments, graphical representations of nodes may be generated based on one or more steps described with reference to FIG. 2 herein.

In step 303, the system determines display locations for the graphical representations of the plurality of data packets in a three-dimensional space. In some embodiments, the system may first determine display locations for a plurality of nodes on the network. In some embodiments, display locations of nodes may be determined according to step 203 described with reference to FIG. 2 herein or a similar step. In some embodiments, the display locations of a data packet may correspond to the current network location of the packet relative to the nodes on the network. For example, if a data packet is traveling between node A and node B, the system may select a location along the representation of the communication channel between nodes A and B as the display location of the data packet. In another example, if a data packet is currently held at a node, the data packet may be displayed inside, next to, or surrounding the node. In some embodiments, data packets held at a node may be displayed when the node is selected by the user. In some embodiments, when a node is selected, the system may display data packets entering and leaving the node via one or more communication channels. In some embodiments, the display location of a data packet may further be determined based on its relative position to other data packets. For example, if a data packet X leaves nodes ahead of data packet Y, data packet X's display location may be further from node A as compared to data packet Y.

In some embodiments, the display locations of data packets may be configurable by users. For example, users may select, arrange, and sort the data channels and/or packets based on various characteristics of the data channels and associated nodes. In some embodiments, a user may select and place one or more data packets into “frames” for inspection and monitoring. The selected data packet may remain visible and accessible through the frame as data continues to flow through different nodes and/or as the user navigates and manipulate through the representation of the network. In some embodiments, the user may select to follow a data packet as it moves through the network and the system may keep the display location of the data packet fixed and display the nodes and/or other data packets at locations relative to the data packet. In some embodiments, the arrangement of displays of data packets and/or data connections affected by the user may be saved by the system and used to display the network in subsequent VR sessions. In some embodiments, the locations of each data packet representation may comprise x, y and z coordinates relative to a reference point in the 3D space and/or to one or more nodes. In some embodiments, graphical representations of data packets in a network may be arranged such that data packets and/or data connections are displays in a plurality of planes.

In step 305, the system causes a VR display device to display the graphical representations of the plurality of data packets in the three-dimensional space of a VR environment. In some embodiments, graphical representations generated in step 302 may be displayed according to the display locations determined in step 303. In some embodiments, the VR environment comprises a main display area where users can view and navigate through the network. In some embodiments, the user may move, rotate, zoom in, and zoom out through the graphical representations of the network in the VR environment with hand motions, body motions, and/or eye movements. In some embodiments, the VR environment may further include other tools for network management such as interactive keyboard, interactive buttons, an interactive menu configured to receive user inputted selections and/or commands, and the like. In some embodiments, the VR environment may emulate a virtual workspace comprising virtual user input device, virtual display devices, widgets (e.g. clock, calendar), and/or decorative elements (e.g. wall coloring, environmental effects, etc.). In some embodiments, the VR environment may comprise representations of the user's hand and/or arm to help users locate their hands relative to objects in the VR space. In some embodiments, the VR environment may comprise representations of one or more “picture frames” configured to display nodes or data packets selected by the user and placed into a picture frame. In some embodiments, a node or a data packets selected and placed into a frame may remain visible and accessible to the user as the user navigates through other data packets in the main display area. In some embodiments, data packets placed in the data frame may be “quarantined” such that one or more nodes stop forwarding the data packet until another action is determined. Examples of a VR environment are provided with reference to FIGS. 8 and 9 herein.

In some embodiments, the VR environment is further configured to simultaneously engage two or more users in the VR environment via a plurality of VR display devices, the two or more users share views of the graphical representations of the plurality of data packets. In some embodiments, manipulations made by one user on the display of representations of the network in the VR environment may be shown to other users sharing the same work space. In some embodiments, the system may further relay communications (e.g. text, voice, gesture) between the users. In some embodiments, the VR environment comprises displays of avatars of each participant of the VR user interface. In some embodiments, users of a VR interface may be given different levels of control permission. For example, a trainer analyst may be permitted to cause real-time changes to the network while a trainee network analyst may only be permitted to observe.

In some embodiments, the VR environment may similarly be configured to display historical data or simulated network data. In some embodiments, the VR environment may be configured to display the status of nodes and/or data flow at an earlier time based on cached information. In some embodiments, the system may be configured to simulate the status of nodes and/or data flow at a later time using a simulation engine. In some embodiments, the VR environment may allow the user to pause the display of the network such that the user can view and interact with the state of a network at a fixed point in time.

In step 307, the system detects a user action. In some embodiments, the user action may be detected via a motion sensor. In some embodiments, the motion sensor may comprise one or more of an optical sensor, a camera, a head motion tracker, an eye tracker, a gesture sensor, a gesture tracking glove, a wearable sensor, and the like. In some embodiments, the motion sensor may comprise a plurality of sensor types (e.g. eye tracker and gesture tracking glove) and may be implemented as one or more devices. In some embodiments, the motion sensor may comprise the motion sensor 129 described with reference to FIG. 1 herein. In some embodiments, user motions may comprise one or more of point, pinch, flick, two-finger point, drag, press, long stare, voice command (e.g. “open,” “change”), etc. Generally, the system may be configured to detect a variety of motions associated with a variety of commands. In some embodiments, the system may be configured to display a command menu in response to a selection action. For example, if a user touches a representation of a node or a data packet in the VR space, the system may display a list of actions next to the representation of the node or the data packet. The user may then select an action from the list by touching an option and/or through speaking a voice command.

In the event that the action detected in step 307 corresponds to an inspection action, in step 310, the system selectively displays the details of one or more of the plurality of nodes or data packets selected by a user. In some embodiments, the inspection action may correspond to the user performing a reverse pinch gesture on the visual representation of the data packet. In some embodiments, the data packet may comprise a data packet moving through the network and/or a data packet being held at a node. In some embodiments, a node may hold a data packet for security quarantine, due to network congestion, due to network addressing issues, and/or other data transport issues. In some embodiments, the inspection action may correspond to the user pointing and/or touching the visual representation of the data packet and saying “inspect,” “details,” “status,” and the like. In some embodiments, the inspection action may comprise the user placing an inspection tool (e.g. a magnifying glass icon) over the representation of the data packet or moving the representation of the data packet into an inspection area. The system may then display details of the data packet in response to such action. In some embodiments, the system may display information extracted from the header, the trailer, and/or the payload of the data packet. In some embodiments, the information may further comprise any transport history recorded by one or more network nodes. Generally, the VR interface may be configured to display any type of data packet information extracted from the data packet itself or recorded by the network. In some embodiments, the displayed information may further be navigable, sortable, searchable, and/or movable through user motions in the 3D space. In some embodiments, the system may be configured to convert the details of the one or more of the plurality of data packets to natural language descriptions before displaying the details of the one or more of the plurality of data packets in the VR environment. For example, the system may use a network directory to translate IP addresses associated with a data packet into URLs or internal device IDs. In some embodiments, translation to natural language may be performed based on a lookup table and/or by parsing search results from a search engine.

In the event that the action detected in step 307 corresponds to a modification action, the process may proceed to step 320. In step 320, the system determines a rerouting command for the data packet selected by the user. In some embodiments, a rerouting command may comprise an action associated with a modification of the data packet's destination and/or route. In some embodiments, the user may perform a specified gesture (e.g. swipe, pinch) or a combination of a gesture and voice command (e.g. touch and say “reset”) on a representation of a pocket to reroute the packet. In some embodiments, rerouting a packet may comprise one or more of routing the packet to a different intermediate node for the same destination, routing the packet to a different destination, routing the packet to a quarantine device, temporarily holding the packet at an intermediate node, etc. In some embodiments, when a data packet is selected, a set of rerouting options may be displayed to the user for selection. In some embodiments, the rerouting command may be inputted through voice command and/or a virtual input device (e.g. virtual keyboard, virtual keypad, etc.). In some embodiments, a user may select a select an intermediate rerouting node, a rerouted destination, and/or a holding location of a packet from the display of the network. In some embodiments, the user may select a plurality of data packets to perform a batch reroute.

In step 311, the rerouting command determined in step 320 is forwarded to one or more nodes. In some embodiments, the system may be configured to use a node-specific lookup table to configure the rerouting command for the node prior to sending the rerouting command. In some embodiments, the rerouting command may cause the node to hold the packet in its memory and not forward it, cause the node to send the data packet to a different destination or intermediate device, and/or reconfigure the header or trailer of the data packet. For example, the node may send the packet to a quarantine device for further handling. In another example, a node may be configured to strip the payload of a packet and add a different header such that the data packet is forwarded to a different destination. After the rerouting command is forwarded, in step 322, the system updates the display of the plurality of data packets based on an updated data flow information aggregated from the network after the rerouting command is executed.

In some embodiments, after steps 320 and 322, the process may return to step 301 and the system may continuously update the VR environment in response to both updated data flow information and user actions in the VR environment.

In some embodiments, a similar process may be used to generate a VR user interface to display historical data and/or simulated data. For example, steps 302-305 may be performed with data previously aggregated from a network or simulated by a computer system. Instead of step 321 and 322, the system may simulate changes to the network based on the selected rerouting command and display the simulated response of the command to the user. In some embodiments, historical or simulated data may be used for analyst training and/or time-delayed analysis of a network event (e.g. connection failure, security breach, etc.).

Referring now to FIG. 4, an illustration of a VR headset is shown. In some embodiments, the VR headset 400 may be configured display one or more VR network management user interfaces described herein. In some embodiments, the VR headset 400 may comprise the VR display device 128 and/or the motion sensor 129 described with reference to FIG. 1 herein.

The VR headset 400 comprises a display unit 410, an optical sensor 412, one or more vibration devices 411, a volume control 413, data adapters 414, a microphone 415, an audio device 430, and a support portion 420.

The display unit 410 may comprise one or more display screens configured to present images to the wearer of the VR headset 400. In some embodiments, the display screen may be configured to display a stereoscopic image. In some embodiments, the optical sensor 412 may be configured to detect the movement of the wearer's eyes inside the display unit. In some embodiments, the optical sensor 412 may be configured to perform retina scans of the eye of the wearer for user authentication. The vibration devices 411 may be configured to provide vibration feedback to the wearer according to the VR user interface. For example, the presence of certain types of data packet and/or alert conditions with one or more appliances may trigger the vibration device on the VR headset 400. In some embodiments, vibration devices 411 configured to provide vibration feedback on different locations on the wearer's body may be associated with different types of alerts. For example, an appliance malfunction may trigger the vibration device on the wearer's forehead while the detection of a malicious data packet may trigger the vibration device near the wearer's temple.

The volume controls 413 may be configured to adjust the volume of the audio device 430 and/or a microphone 415 on the VR headset 400. The data adapter 414 may comprise data ports (e.g. USB, SATA, etc.) and/or wireless adapters (e.g. Wi-Fi, Bluetooth, etc.) configured to allow the VR headset 400 to exchange information with an external data source. The microphone 415 may be configured to detect sounds (e.g. voice command) from the wearer. The audio device 430 may be configured to play sounds from the VR user interface to the user. In some embodiments, different audio sounds may be assigned to different alert conditions, data packet types, and/or appliance statuses. For example, the audio device 430 may play one sound when an appliance malfunction is detected and play a different sound when a malicious data packet is detected. The support portion 420 may comprise a “cage” or cap-like structure configured to be worn by a user to secure the VR headset 400 on the user's head.

The positions, configurations, appearances, and relative sizes of the various elements of the VR headset 400 are provided as an illustration only. VR headsets comprising different elements in different arrangements may be used with various embodiments of the systems and methods described herein. In some embodiments, one or more of the optical sensor 412, the vibration devices 411, the volume control 413, the data adapters 414, the microphone 415, the audio device 430, and the support portion 420 may be optional to a VR headset according to various embodiments described herein.

Referring now to FIG. 5, an illustration of a motion sensing glove is shown. The glove may be configured to be worn on one or both hands of a user to interact with a VR environment described herein. The glove 500 comprises a plurality of fingertip sensors 501 positioned at one or more fingertips, a finger movement sensor 502, a wrist movement sensor 503, and a vibration device 504.

In some embodiments, the fingertip sensor 501 may comprise fingerprint scanners configured to collect fingerprints from the wearer of the glove 500 for user authentication. In some embodiments, the fingertip sensors 501 may comprise a click sensor configured to detect when the fingertip touches a hard surface to perform a “click.” The finger movement sensors 502 may comprise sensors that run along the length of one or more fingers that are configured to detect the bending and movement of one or more fingers. In some embodiments, the finger movement sensors 502 may cluster at a cluster device that aggregates movement information for each finger. The wrist movement sensor 503 may be configured to detect the movement and the rotation of the wrist. In some embodiments, the wrist movement sensor 503 may comprise an inertial measurement unit (IMU), an accelerometer, and/or a gyroscope. The vibration device 504 may be configured to provide vibration feedback to the wearer based on the VR environment. For example, the presence of certain types of data packet and/or alert conditions may trigger the vibration feedback on the glove 500. In some embodiments, vibration devices 504 associated with different locations on the wearer's body may be associated with different types of alerts. For example, an appliance malfunction may cause trigger the vibration device on the wearer's right hand while the detection of a malicious data packet may trigger the vibration device on the wearer's left hand.

The positions, configurations, appearances, and relative sizes of the various elements of the glove 500 are provided as an illustration only. A motion sensing glove comprising different elements in different arrangements may be used with various embodiments of the systems and methods described herein. In some embodiments, one or more of the fingertip sensors 501, the finger movement sensor 502, the wrist movement sensor 503, and the vibration device 504 may be optional for a motion sensing glove. In some embodiments, an optical device such as a camera and/or an infrared detector may be used to detect hand motion in place of or in addition to a motion sensing glove.

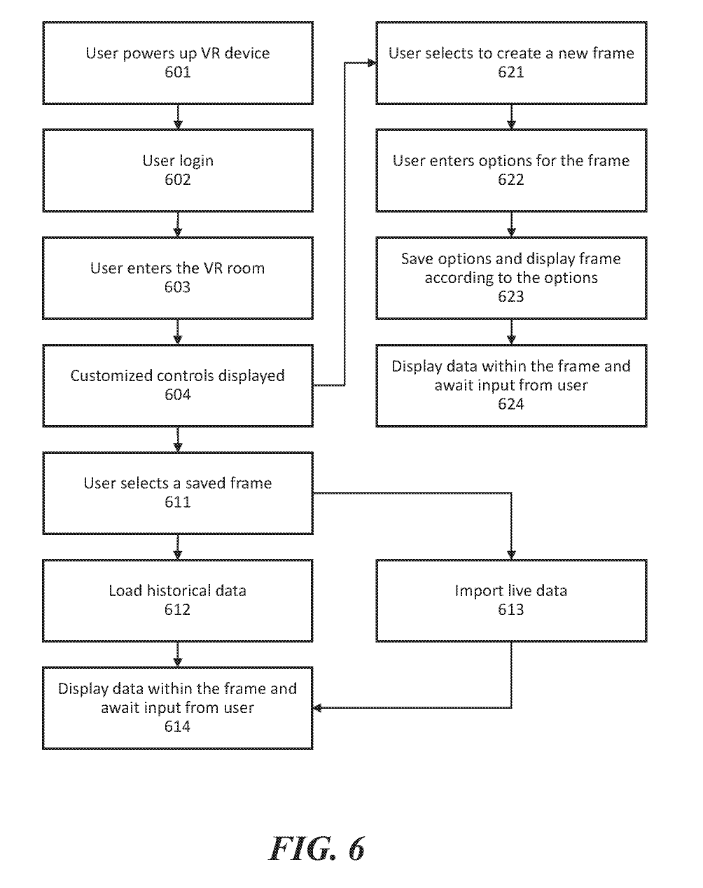

Referring now to FIG. 6, a method for providing a virtual reality network management user interface is shown. In some embodiments, the steps shown in FIG. 6 may be performed by a processor-based device such as a control circuit executing a set of computer readable instructions stored on a computer readable memory. In some embodiments, one or more steps of FIG. 6 may be performed by one or more of the control circuit 112 of the computer system 110 and/or the VR display device 128 described with reference to FIG. 1 herein.

In step 601, a user powers up a VR device. In step 602 the user logs into the VR user interface. In some embodiments, the user log-in may be based on a retina scan, a fingerprint scan, and/or with a security token. In step 603, the user enters a VR room for network management. In some embodiments, the VR room for network management may comprise virtual controls such as virtual keyboards, customized buttons, representations of network management tools, etc. In step 604, customized control options (e.g. “favorites”) are displayed to the user in the VR space. In step 611, the user may select a saved session and/or previously configured picture frame. If the selected frame is associated with historical data, in step 612, the system retrieves historical data from a storage device and loads the data into the user interface. If the selected frame is associated with live data, the system may import live data from the network. In some embodiments, the system may connect to appliances on the network to stream live data in step 613. In step 614, the system displays the data in the frame and waits for input from the user.

In step 621, the user may select to create a new frame in the VR user interface. In step 622, the user enters options for the frame. In some embodiments, the user can select appliance(s), appliance type(s), data packet(s), data packet type(s), etc. to include in the frame. In some embodiments, the user may further configure the display location, display size, dimension, and orientation of the frame. In some embodiments, the user may move the frame around in the VR environment to choose a display location for the frame for subsequent sessions. In step 623, the system saves the configuration options for the new frame and display the new frame according to the configuration options. In step 624, the system displays the data in the frame and waits for input from the user.

In some embodiments, the system may display a plurality of frames in the VR environment each individually updated to display data associated with data packets and/or appliances associated with the frame. The user may choose to inspect and interact with one or more frames in the VR environment with user motion.

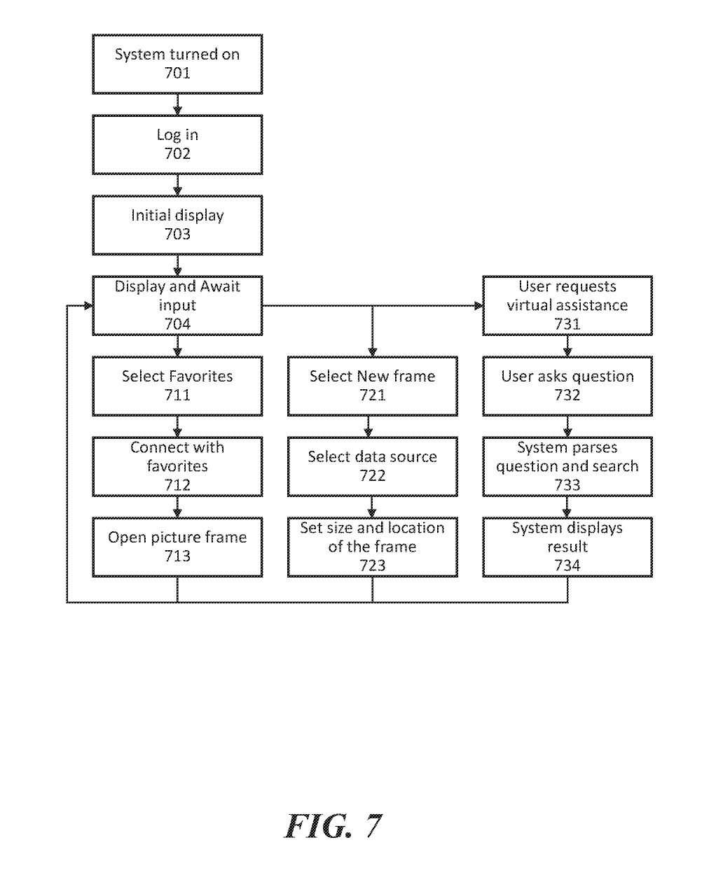

Referring now to FIG. 7, a method for providing a virtual reality network management user interface is shown. In some embodiments, the steps shown in FIG. 7 may be performed by a processor-based device such as a control circuit executing a set of computer readable instructions stored on a computer readable memory. In some embodiments, one or more steps of FIG. 7 may be performed by one or more of the control circuit 112 of the computer system 110 and/or the VR display device 128 described with reference to FIG. 1 herein.

In step 701, the system is turned on. In step 702, the user logs into the system. In some embodiments, user authentication may be based on fingerprint scan, retina scan, and/or a security token. In step 703, the system provides an initial display of the VR network management user interface. In some embodiments, the initial display may comprise one or more of room walls, a virtual keyboard, pointers, and predefined settings of the user. In some embodiments, the initial display may comprise frames and other setting configured during previous VR user interface sessions. In step 704, the user interface is displayed while the system waits for input from the user.

If the user selects one of the preset “favorite” frames, the process proceeds to step 711. In step 712, the system connects with devices and/or databases associated with the selected frames. In some embodiments, a frame may be configured to display real-time network data, historical network data, and/or simulated data. In step 713, the selected frame is “opened” and the user may interact with the information displayed in the frame.

If the user selects to create a new frame, the system proceeds to step 721. In step 722, the user selects a data source associated with the frame. In some embodiments, the data source may comprise one or more of a network connection, a network node, an appliance, and a database of historical network data. In step 723, the user sets the size and location of the frame. In some embodiments, the user may use a dragging motion, a pinching motion, and/or a reverse-pinch motion to set the size and location of the frame. If the user requests virtual assistance, the process proceeds to step 731. In step 732, the user may present a question to the virtual assistance through voice command and/or a virtual keyboard. In step 733, the system parses the question and performs a search in the assistance database and/or the Internet. In step 734, the system displays the result of the search to the user. In some embodiments, after steps 713, 723, and/or 734, the process returns to step 704 and the system waits for further input from the user.

Referring now to FIG. 8, an illustration of a VR network management user interface is shown. The VR user interface 800 comprises a plurality of frames 810, 820, 830, and 820, a virtual control pad 840, and representations of the user's hands 805. In some embodiments, the frames may comprise frames for viewing appliances, data packets, and/or the network. In some embodiments, the frames may display real-time, historical, and/or simulated data. In some embodiments, the frames may display data in 2D or 3D layout. In some embodiments, the framed are laid out in a 3D space on a plurality of planes. In some embodiments, the user may grab and drag the frames to relocate and arrange the frame in the VR environment. In some embodiments, the user may pull on corners of the frame with hand motion to resize the frame. In some embodiments, the user interface may further comprise other decorative and widget elements (e.g. plants, photos) and/or widgets (e.g. clock, calendar, memo pad, etc.) customized by the user. In some embodiments, data may be displayed as floating icons in a space outside of the frames. For example, a user may select a frame associated with appliance data on a network, and the representations of appliances may then be displayed in a 3D layout in front of the user. The virtual control pad 840 may comprise a virtual keyboard and/or a plurality of custom function buttons. In some embodiments, the user may interact with the data displayed in one or more of the frames via the virtual control pad 840, hand motions, and/or voice command. The representations of the user's hands 805 may move according to the tracked locations and/or gestures of the user's hands to help the user locate their hands in the VR space.

Referring now to FIG. 9, an illustration of a VR network management user interface is shown. The VR user interface 900 comprises graphical representations of nodes 902 and 905, data packets 910, and a quarantine frame 920. In FIG. 9, data packets 910 flowing from node 902 to node 905 is shown. The representations of the data packets 910 include visual identifiers comprising different patterns to show different characteristics associated with the data packets 910. In some embodiments, the visual indicators of representations of data packets may represent one or more of data packet origin, data packet destination, file type, data security level, data flow speed, etc. A user may touch and move one of the data packets 910 in the data flow to place the packet into the quarantine frame 920. In some embodiments, the action of moving a data packet into a quarantine frame may send a rerouting command to the receiving node, node 905. The receiving node 905 may then be instructed to hold the data packet in its memory until further instructions are received or may be instructed to send the data packet to a quarantine device instead of its original destination. In some embodiments, a user may select data packets 910 in the quarantine frame to inspect the packets. In some embodiments, a user may keep the packet in quarantine, destroy the packet, or release the packet back into the data flow by dragging the packet back into the representation of the data flow. In some embodiments, the VR user interface 900 may be displayed in a frame such as the frames described in FIG. 8 or in a different user interface. In some embodiments, when a frame in the VR user interface corresponding to the data flow between nodes 902 and 905 is selected, the VR user interface 900 may be displayed in a 3D layout in front of the user.

The user interfaces shown in FIGS. 8 and 9 are provided as examples only. The appearances and the features of a VR network management user interface may be variously configured without departing from the spirit of the present disclosure.

In some embodiments, computer appliance and appliance interface refer to a hardware device with integrated software (e.g. firmware) that may be proprietary in nature. Computer appliances are often specifically designed to not allow users to change the firmware integrated into the computer appliance or manipulate the configurations of the appliance. Appliances designed to function a specific way are often coupled with a tailored operating system that is generally proprietary in nature, operate in conjunction with specialized hardware, and is generally not compatible with other systems. In some embodiments, a user is required to log in through a web page portal from another device to make configuration changes to their computer appliances.

In some embodiments, a virtual appliance interface provides a graphical user interface (GUI) with plugins to allow users to remotely manage various facets of an appliance. Management and control of appliances may be accomplished through plugins installed into the GUI. Technicians may navigate the GUI and interface with appliances to access configurations and make alterations to the appliance from the user interface.

In some embodiments, after a user logs into the virtual appliance GUI implemented with a VR environment, a user may interface and manage appliance firewalls, update the interface and features, remotely log in and manage features, manipulate settings of the interfaces, and upload plugins to the interface. In some embodiments, the system may manage storage appliances to provide storage, mirror disk, and strip data. In some embodiments, the system may manage network appliances to control firewall protection on routers, manage transport layer security messaging, access specialized networking protocols, and control bandwidth multiplexing. In some embodiments, the system may manage firewall appliances designed to safeguard networks from threats, security appliances designed to safeguard networks or computers from threats, and anti-spam appliances design to safeguard email and eliminate spam messages. In some embodiments, the system may manage software appliances and/or JeOS (Just Enough Operating System) comprising software applications for industry standard hardware and/or a virtual machine. In some embodiments, the system may manage virtual machine appliances comprising a hypervisor style embedded operating system running on appliance hardware. A hypervisor layer may be matched to the hardware of the appliance that cannot be changed by the customer, but the customer may load other operating systems and applications onto the appliance in the form of virtual machines. In some embodiments, the system may manage customer appliances such as digital video recorders, residential gateways, network storage devices, video game consoles, etc. In some embodiments, the system may manage industrial automation appliances.

There are several design patterns adopted by computer appliance vendors, which, in some embodiments, may be integrated with the virtual appliance interface via plugin functionalities. Plugins may allow users to work with the different design patterns within the virtual appliance interface. In some embodiments, a vendor may a builds an application-specific integrated circuit (ASIC) without separate software or operating system. This type of appliances generally has a limited interface and is terminal console-based or web-based to allow some basic configuration by the IT staff. The manufacturer may provide some way of accessing deeper configuration mechanisms via a plug-in. Example, with Azul Systems' Vega 3 Java Compute Appliance, a plugin may access special hardware modifications to the chip to enable java application scaling. In some embodiments, a vendor may use or create a basic processor-based system and design a new operating system that integrates the application into the operating system through special software kernel. These types of devices are often sealed so that a user has no access to reinstall the operating system or replace it with another operating system. Users are often restricted to a small group of configuration commands, while the more detailed and lower level functions of the operating system are only available to the vendor. The more this locked down approach is carried out, the closer this type of device comes to appearing like an ASIC device.

In some embodiments, vendors may use off-the-shelf computers and operating systems, but the user interface and device are designed such that the user cannot access anything on the computer except through the application interface that the vendor has provided. Since the underlying computer architecture is locked down and essentially invisible, it becomes difficult to discern that the device is implemented with general purpose hardware and operating system. Linux has become the operating system of choice for this type of appliance, commonly referred to as a software appliance.

In some embodiments, the hardware of an appliance may disappear entirely and become a so-called virtual appliance or virtual software appliance, which uses any one of a number of virtual machine technologies. A virtual appliance may comprise software plus the operating system as in the specialized application alternative. In some embodiments, the above techniques are mixed. For example, a VPN appliance might contain a limited access software firewall running on Linux with an encryption ASIC to speed up the VPN access. In some embodiments, some computer appliances may use solid state storage while others use a hard drive to load an operating system and mixes the two methods. For example, an ASIC printer server might allow an optional hard drive for job queueing. In another example, a Linux-based device may encode Linux in firmware so that a hard drive is not needed to load the operating system.

In some embodiments, an appliance controller interface may handle communications with a number of Websense management interfaces, communicate with the Websense Data Security server, provide inter-appliance communication, transport non-HTTP and non-HTTPS protocol enforcement, and/or handles Websense Master Database downloads via the Internet (unless your site uses P1 for database downloads). Initial configuration of the appliance controller interface is completed when the appliance is first powered on and a firstboot script may prompt a user for the values needed to configure interface.

Network analysts generally have limited interaction with the information flowing throughout the network. A network analyst may use multiple monitors to monitor packets as they flow throughout the network, which can be strenuous on the physiology of the analyst. An analyst's' view of information flowing throughout the network on a two-dimensional display is also often limited to a microscopic view without a macroscopic view. Training less-experienced analysts on network information can also be difficult

Through the virtual reality medium described herein, analysts may interact with networks and analyze network protocol in an interactive, immersive, and intuitive way. The virtual reality environment may broaden the analyst's field of view over a network, and the analyst may choose a microscopic view through simple interactions. The virtual reality environment can provide a less physically strenuous way for analysts to manage network traffic as compared to the desktop two-dimensional approach. Training may also be more intuitive and immersive in the virtual reality medium. For example, less-experienced analysts may enter into the virtual reality network with other more experienced analysts to engage the network cooperatively.

In some embodiments, as information flows through the network, data may be displayed as visuals with unique identifiers that are specific to a criterion of information. Analysts may then interact with information passing through the network by moving packets, capturing information passing through the network, and make alterations to the flow of packets. In some embodiments, the system may allow analysts to redirect, stop, and/or isolate packet flow. In some embodiments, an analyst may change the destination of packets via the VR interface. In some embodiments, analysts may exchange information captured from the network between them.

In some embodiments, representation of information and data packets on a network may be color-coded or shape-coded and/or may comprise an audio or digital signature. In some embodiments, the user interface may be configured to generate audio alerts based on the detection of certain types of information and/or data packet on the network. For example, audio alerts may be assigned by type, filter, etc.

In some embodiments, the VR user interface may comprise a virtual file cabinet/organizer for packet organization and/or a virtual network operations center (NOC) for streamlining the process of analyzing network traffic. In some embodiments, the display device for the user interface may comprise one or more of a 2D display, a 3D display, a 4D display, a virtual reality display, and/or an augmented reality display. In some embodiments, analysts may navigate the VR environment by virtual-physical movements (e.g. Virtuix Omni), audio inputs, gesture control, search queries, and/or interactive captions.

In some embodiments, the VR environment allows analysts to analyze specific data streams and view a larger spectrum of streams. For example, a microscope view may allow analysts to “zoom in” on a specific stream and a macroscope view may allow analysts to have a bird's-eye view of a data stream. In some embodiments, flags may be used as indicators to mark certain packets and may be automatically applied to packets based on previously inputted data from data processed, stored, and learned. In some embodiments, flags may be applied while packets are moving throughout the network and/or moved by an analyst.

In some embodiments, the system may comprise an Artificial Intelligence engine configured to perform automated functions through data gathered and machine-learning. The Artificial intelligence engine may be configured to use pattern recognition to identify alert conditions such as Distributed Denial of Service (DDOS), etc. In some embodiments, the Artificial intelligence engine may learn analyst interactions to generate an autonomous solution for future applications.

In some embodiments, the system may comprise a training application user interface. In the training application, novice and beginner analysts may enter the virtual environment with expert analysts who can assist the less-experienced analysts in interacting with the VR environment and the Network. In some embodiments, training modules may be created from previously stored information, allowing the trainee to interact with the environment without having an effect on real-time information.

In some embodiments, the systems and methods described here may provide cost savings by reducing the number physical user interface devices (e.g. monitors, keyboards, mice, etc.) and reduce the number of analysts required to monitor data and devices on a network. The system may increase network security by allowing analysts to monitor and secure the network in a more streamlined approach and providing hands-on training. In some embodiments, the user interface may provide a rewind feature that allows analysts to rewind network flow to analyze previous data flow to see who and where a packet came from. In some embodiments, the system may allow an analyst to fast-forward network flow to see predicted locations of packets at a further time. In some embodiments, the VR environment may visually represent one or more layers of information in the 7-layer Open Systems Interconnection model (OSI model). For example, visual representations may include indicators associated with the physical layer (e.g. media, signal and binary transmission: DSL, ISDN, SDH), the data link layer (e.g. physical Addressing: RSTP, PPP, Ethernet, 802.11), the network layer (e.g. oath determination and logical addressing: IPv4, IPv6), the transport layer (e.g. end-to-end connections and reliability: TCP, UDP, RDP), the session layer (e.g. translation, compression, encryption: SSL, JPEG.), and/or the application layer (e.g. network process to application: FTP, DNS, HTTP, Telnet).

In some embodiments, filters may be applied to the network to allow the analyst to target specific information passing through the network. In some embodiments, information captured within the virtual reality network management user interface may be exported to other programs, such as XML, Postscript, CSV, plain text, etc. In some embodiments, information captured within the virtual reality network can be exported internally to visual diagrams, browsers, rooms, spaces, GUI, etc. and may comprise offline or real-time information. In some embodiments, the VR user interface may run on any operating system such as Windows, Linux, OS X, Solaris, FreeBSD, NetBSD, etc. In some embodiments, the VR network analysis interface may comprise the integration of VoIP analysis.

In some embodiments, the VR network analyzer may be configured to capture various file formats such as Tcpdump (libpcap, Pcap NG, Catapult DCT200, Cisco Secure IDS iplog, Microsoft Network Monitor, Network General Sniffer, Sniffer Pro, NetXray, Network instruments Observer, NetScreen snoop, Novell LANalyzer, RADCOM WAN/LAN Analyzer, Shomiti/Finisar Surveyor, Tektronix, k12xx, Visual Networks Visual UpTime, WildPackets EtherPeek/TokenPeek/AiroPeek, etc. In some embodiments, compressed and zipped files may be decompressed on the fly through the system may via controls in the VR interface. In some embodiments, the VR user interface may be configured to allow data to be read from sources such as Ethernet, IEEE 802.11, PPP/HDLC, ATM, Bluetooth, USB, Token Ring, Frame Relay, FDDI, etc. In some embodiments, the virtual reality network management user interface may provide decryption support for protocols such as Psec, ISAKMP, Kerberos, SNMPv3, SSL/TLS, WEP, WPA, WPA2, etc.

In some embodiments, interaction mediums for users may be integrated into the virtual reality environment. For example, the users in the VR environment may communicate via audio messages and/or hand gesture messages, share virtual objects, send/receive task lists and text-based lists, share specific data packets and streams, etc. In some embodiments, haptic feedback devices may be integrated into the virtual reality network management user interface.

In some embodiments, a system for providing the VR network and/or appliance user interface may comprise one or more of a haptic device (e.g. Glove one), a VR headset (e.g. Oculus Rift, VIVE, Google Cardboard, etc.), a motion capture device (e.g. Virtuix Omni, Room Alive, Sony's Beacon system), and/or sensory emulation devices.

In one embodiment, a system for providing a virtual reality (VR) user interface for managing networked appliances comprises an appliance communication device configured to communicate with a plurality of appliances on a network, a motion sensor configured to receive user input, a VR display device, and a control circuit coupled to the appliance communication device, the motion sensor, and the VR display device. The control circuit being configured to: aggregate configuration data and real-time status information from the plurality of appliances via the appliance communication device, generate graphical representations of the plurality of appliances based on the configuration data and the real-time status information associated with each of the plurality of appliances, the graphical representations of each the plurality appliances comprising at least one visual indicator associated with a characteristic of a corresponding appliance, determine display locations for the graphical representations of the plurality of appliances in a three-dimensional space, cause the VR display device to display the graphical representations of the plurality of appliances in the three-dimensional space of a VR environment, detect user motion via the motion sensor, determine an action in the VR environment based on the user motion, in an event that the action corresponds to an inspection action: selectively display the configuration data and/or the real-time status information of one or more of the plurality of appliances selected by a user, in an event that the action corresponds to an appliance modification action: determine a configuration change command for at least one appliance selected by the user based on the action, forward the configuration change command to the at least one appliance, and update the display of the plurality of appliances based on an updated configuration data and an updated real-time status information aggregated from the plurality of appliances after the configuration change command is executed.

In one embodiment, a method for providing a virtual reality (VR) user interface for managing networked appliances comprises aggregating, at a control circuit, configuration data and real-time status information from the plurality of appliances via an appliance communication device configured to communicate with the plurality of appliances on a network, generating, with the control circuit, graphical representations of the plurality of appliances based on the configuration data and the real-time status information associated with each of the plurality of appliances, the graphical representations of each the plurality appliances comprising at least one visual indicator associated with a characteristic of a corresponding appliance, determining display locations for the graphical representations of the plurality of appliances in a three-dimensional space, causing a VR display device to display the graphical representations of the plurality of appliances in the three-dimensional space of a VR environment, detecting user motion via a motion sensor, determining an action in the VR environment based on the user motion, in an event that the action corresponds to an inspection action: selectively displaying the configuration data and/or the real-time status information of one or more of the plurality of appliances selected by a user, in an event that the action corresponds to an appliance modification action: determining a configuration change command for at least one appliance selected by the user based on the action, forwarding the configuration change command to the at least one appliance, and updating the display of the plurality of appliances based on an updated configuration data and an updated real-time status information aggregated from the plurality of appliances after the configuration change command is executed.

In one embodiment, an apparatus for providing a virtual reality (VR) user interface for managing networked appliances comprises a non-transitory storage medium storing a set of computer readable instructions, and a control circuit configured to execute the set of computer readable instructions which causes to the control circuit to: aggregate configuration data and real-time status information from the plurality of appliances via an appliance communication device configured to communicate with the plurality of appliances on a network. generate graphical representations of the plurality of appliances based on the configuration data and the real-time status information associated with each of the plurality of appliances, the graphical representations of each the plurality appliances comprising at least one visual indicator associated with a characteristic of a corresponding appliance, determine display locations for the graphical representations of the plurality of appliances in a three-dimensional space, cause a VR display device to display the graphical representations of the plurality of appliances in the three-dimensional space of a VR environment, detect user motion via a motion sensor, determine an action in the VR environment based on the user motion, in an event that the action corresponds to an inspection action: selectively display the configuration data and/or the real-time status information of one or more of the plurality of appliances selected by a user, in an event that the action corresponds to an appliance modification action: determine a configuration change command for at least one appliance selected by the user based on the action, forward the configuration change command to the at least one appliance, and update the display of the plurality of appliances based on an updated configuration data and an updated real-time status information aggregated from the plurality of appliances after the configuration change command is executed.

In one embodiment, a system for providing a virtual reality (VR) user interface for managing network data flow comprise a network communication device configured to communicate with a plurality of nodes on a network, a motion sensor configured to receive user input, a VR display device, and a control circuit coupled to the network communication device, the motion sensor, and the VR display device. The control circuit being configured to: aggregate data flow information from the plurality of nodes via the network communication device, generate graphical representations of a plurality of data packets traveling between one or more of the plurality of nodes based on the data flow information, a graphical representation of a data packet of the plurality of data packets comprising at least one visual indicator associated with a characteristic of the data packet, determine display locations for the graphical representations of the plurality of data packets in a three-dimensional space, cause the VR display device to display the graphical representations of the plurality of data packets in the data flow between the plurality of nodes in the three-dimensional space of a VR environment, detect user motion via the motion sensor, determine an action in the VR environment based on the user motion, in an event that the action corresponds to an inspection action: selectively display details of one or more of the plurality of data packets selected by a user, in an event that the action corresponds to a modification action: determine a rerouting command for at least one data packet selected by the user based on the action, forward the rerouting command to at least one node, and update the display of the plurality of data packets based on an updated data flow information aggregated from the network after the rerouting command is executed.

In one embodiment, a method for providing a virtual reality (VR) user interface for managing network data flow comprises aggregating, with a control circuit, data flow information from the plurality of nodes via a network communication device, generating, with the control circuit, graphical representations of a plurality of data packets traveling between one or more of the plurality of nodes based on the data flow information, a graphical representation of a data packet of the plurality of data packets comprising at least one visual indicator associated with a characteristic of the data packet, determining display locations for the graphical representations of the plurality of data packets in a three-dimensional space, causing a VR display device to display the graphical representations of the plurality of data packets in the data flow between the plurality of nodes in the three-dimensional space of a VR environment, detecting user motion via a motion sensor, determining, with the control circuit, an action in the VR environment based on the user motion, in an event that the action corresponds to an inspection action: selectively displaying details of one or more of the plurality of data packets selected by a user in the VR environment, in an event that the action corresponds to a modification action: determining a rerouting command for at least one data packet selected by the user based on the action, forwarding the rerouting command to at least one node, and updating the display of the plurality of data packets based on an updated data flow information aggregated from the network after the rerouting command is executed.

In one embodiment, an apparatus for providing a virtual reality (VR) user interface for managing network data flow comprises a non-transitory storage medium storing a set of computer readable instructions, and a control circuit configured to execute the set of computer readable instructions which causes to the control circuit to: aggregate data flow information from the plurality of nodes via a network communication device, generate, with the control circuit, graphical representations of a plurality of data packets traveling between one or more of the plurality of nodes based on the data flow information, a graphical representation of a data packet of the plurality of data packets comprising at least one visual indicator associated with a characteristic of the data packet, determine display locations for the graphical representations of the plurality of data packets in a three-dimensional space, cause a VR display device to display the graphical representations of the plurality of data packets in the data flow between the plurality of nodes in the three-dimensional space of a VR environment, detect user motion via a motion sensor, determine, with the control circuit, an action in the VR environment based on the user motion, in an event that the action corresponds to an inspection action: selectively display details of one or more of the plurality of data packets selected by a user in the VR environment, in an event that the action corresponds to a modification action: determine a rerouting command for at least one data packet selected by the user based on the action, forward the rerouting command to at least one node, and update the display of the plurality of data packets based on an updated data flow information aggregated from the network after the rerouting command is executed.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for providing a virtual reality (VR) user interface for managing network data flow comprising:
a network communication device configured to communicate with a plurality of nodes on a network;
a motion sensor configured to receive user input;
a VR display device; and
a control circuit coupled to the network communication device, the motion sensor, and the VR display device, the control circuit being configured to:
aggregate data flow information from the plurality of nodes via the network communication device;
generate graphical representations of a plurality of data packets traveling between one or more of the plurality of nodes based on the data flow information, a graphical representation of a data packet of the plurality of data packets comprising at least one visual indicator associated with a characteristic of the data packet;
determine display locations for the graphical representations of the plurality of data packets in a three-dimensional space;
cause the VR display device to display the graphical representations of the plurality of data packets in the data flow between the plurality of nodes in the three-dimensional space of a VR environment;
detect user motion via the motion sensor;
determine an action in the VR environment based on the user motion;
in an event that the action corresponds to an inspection action:
selectively display details of one or more of the plurality of data packets selected by a user;
in an event that the action corresponds to a modification action:
determine a rerouting command for at least one data packet selected by the user based on the action;
forward the rerouting command to at least one node; and
update the display of the plurality of data packets based on an updated data flow information aggregated from the network after the rerouting command is executed.

2. The system of claim 1, wherein the control circuit further generates graphical representations of a plurality of nodes in the VR environment.

3. The system of claim 1, wherein the control circuit is further configured to convert the details of the one or more of the plurality of data packets to natural language descriptions before displaying the details of the one or more of the plurality of data packets in the VR environment.

4. The system of claim 1, wherein the graphical representations of the plurality of data packets are arranged in a three-dimensional layout in the VR environment.

5. The system of claim 1, wherein the VR environment further comprises representations of one or more of interactive keyboard, interactive buttons, an interactive menu configured to receive user inputted selections and/or commands.

6. The system of claim 1, wherein the VR environment further comprises representations of one or more picture frames configured to display data associated with one or more data packets selected by the user and placed into a picture frame.

7. The system of claim 1, the control circuit is configured to simultaneously engage two or more users in the VR environment via a plurality of VR display devices, the two or more users share views of the graphical representations of the plurality of data packets.

8. The system of claim 7, wherein the VR environment comprises graphical representations of the two or more users and relays communications between the two or more users.

9. The system of claim 1, wherein the motion sensor comprises one or more motion sensing gloves.

10. The system of claim 1, wherein the VR display device comprises a head-mounted display device comprising a display screen, an audio device, an eye movement sensor, a wireless communication device, and a vibration feedback device.

11. A method for providing a virtual reality (VR) user interface for managing network data flow comprising:
aggregating, with a control circuit, data flow information from the plurality of nodes via a network communication device;
generating, with the control circuit, graphical representations of a plurality of data packets traveling between one or more of the plurality of nodes based on the data flow information, a graphical representation of a data packet of the plurality of data packets comprising at least one visual indicator associated with a characteristic of the data packet;
determining display locations for the graphical representations of the plurality of data packets in a three-dimensional space;
causing a VR display device to display the graphical representations of the plurality of data packets in the data flow between the plurality of nodes in the three-dimensional space of a VR environment;
detecting user motion via a motion sensor;
determining, with the control circuit, an action in the VR environment based on the user motion;
in an event that the action corresponds to an inspection action:
selectively displaying details of one or more of the plurality of data packets selected by a user in the VR environment;
in an event that the action corresponds to a modification action:
determining a rerouting command for at least one data packet selected by the user based on the action;
forwarding the rerouting command to at least one node; and
updating the display of the plurality of data packets based on an updated data flow information aggregated from the network after the rerouting command is executed.

12. The method of claim 11, further comprising:
generating graphical representations of a plurality of nodes in the VR environment.

13. The method of claim 11, further comprising:
converting the details of the one or more of the plurality of data packets to natural language descriptions before displaying the details of the one or more of the plurality of data packets in the VR environment.

14. The method of claim 11, wherein the graphical representations of the plurality of data packets are arranged in a three-dimensional layout in the VR environment.

15. The method of claim 11, wherein the VR environment further comprises representations of one or more of interactive keyboard, interactive buttons, an interactive menu configured to receive user inputted selections and/or commands.

16. The method of claim 11, wherein the VR environment further comprises representations of one or more picture frames configured to display data associated with one or more data packets selected by the user and placed into a picture frame.

17. The method of claim 11, further comprising:
simultaneously engaging two or more users in the VR environment via a plurality of VR display devices, the two or more users share views of the graphical representations of the plurality of data packets.

18. The method of claim 17, wherein the VR environment comprises graphical representations of the two or more users and relays communications between the two or more users.

19. The method of claim 11, wherein the motion sensor comprises one or more motion sensing gloves.

20. The method of claim 11, wherein the VR display device comprises a head-mounted display device comprising a display screen, an audio device, an eye movement sensor, a wireless communication device, and a vibration feedback device.

21. An apparatus for providing a virtual reality (VR) user interface for managing network data flow comprising:
a non-transitory storage medium storing a set of computer readable instructions; and
a control circuit configured to execute the set of computer readable instructions which causes to the control circuit to:
aggregate data flow information from the plurality of nodes via a network communication device;
generate, with the control circuit, graphical representations of a plurality of data packets traveling between one or more of the plurality of nodes based on the data flow information, a graphical representation of a data packet of the plurality of data packets comprising at least one visual indicator associated with a characteristic of the data packet;
determine display locations for the graphical representations of the plurality of data packets in a three-dimensional space;
cause a VR display device to display the graphical representations of the plurality of data packets in the data flow between the plurality of nodes in the three-dimensional space of a VR environment;
detect user motion via a motion sensor;
determine, with the control circuit, an action in the VR environment based on the user motion;
in an event that the action corresponds to an inspection action:
selectively display details of one or more of the plurality of data packets selected by a user in the VR environment;
in an event that the action corresponds to a modification action:
determine a rerouting command for at least one data packet selected by the user based on the action;
forward the rerouting command to at least one node; and
update the display of the plurality of data packets based on an updated data flow information aggregated from the network after the rerouting command is executed.
